(19) United States
(12) Patent Application Publication
(10) Pub. No.: US 2007/0027789 A1
(43) Pub. Date: Feb. 1, 2007

(54) System for financing renewable energy generation projects and other "green" energy generation projects

(75) Inventor: Aaron Gleich, New York, NY (US)

Correspondence Address: PATENT ADMINISTRATOR;KATTEN MUCHIN ROSENMAN LLP, 1025 THOMAS JEFFERSON STREET, N.W., EAST LOBBY: SUITE 700, WASHINGTON, DC, 20007-5201, US

(73) Assignee: Enyrgy, LLC

(21) Appl. No.: 11/494,426

(22) Filed: Jul. 27, 2006

Related U.S. Application Data
(60) Provisional application No. 60/704,205, filed on Jul. 29, 2005.

(51) Int. Cl. G06Q 40/00

(52) U.S. Cl. 705/36 R; 705/38

(57) ABSTRACT

A novel project financing method for financing industrial projects such as renewal energy generation projects and other “green” energy generation projects is disclosed. The invention provides a hybrid of known corporate financing and project financing approaches, in order to provide low-cost, non-recourse financing. In a preferred system, a pension fund is identified as the principal provider of credit support by the project developer early in the development process. The pension fund is motivated to provide credit because the inventive system is structured to limit the credit provider's exposure to development risks and also because pension funds typically have investment guidelines that require their investment managers to make socially responsible investments, such as investing in “green” energy generation products. The project is financed using low cost bonds, which may be variable rate demand bonds or tax credit bonds, which are issued by a public authority or utility for the benefit of a special purpose entity that serves as the owner of the project and the borrower under the project financing. The pension fund, or its financial intermediary, will provide credit support for the bonds, typically in the form of a guaranty.

### CROSS REFERENCE TO RELATED APPLICATIONS

This application claims priority to and the benefit of U.S. provisional patent application No. 60/704,205, filed on Jul. 29, 2005, hereby incorporated by reference.

### FIELD OF THE INVENTION

The present invention relates to systems for financing mechanisms for renewable energy generation projects and other “green” energy generation projects.

### BACKGROUND OF THE INVENTION

The two principal traditional approaches to financing industrial projects are (i) full recourse on-balance sheet corporate financings and (ii) non-recourse or limited recourse off-balance sheet project financings.

In corporate financings, the project sponsor (typically, with respect to energy generation projects, a utility, an independent power producer or a generation portfolio company) either takes out full recourse loans to finance the project or provides full recourse guarantees in respect of a project affiliate's loans. Such loans (or guaranty obligation in respect of such loans) are reflected on the balance sheet of the project sponsor. The complexity of documentation in respect of, and the interest rate and fee pricing that is available for, corporate financings depend on the creditworthiness of the project sponsor. As compared to project financing, corporate financing offers the advantages of simpler and relatively fast arrangement and implementation. These advantages are, however, lost to most project sponsors because of the disadvantages inherent to corporate financing, (e.g.,: (i) the financial risks are squarely borne by the project sponsor and (ii) the balance sheet of the project sponsor is burdened by on-balance sheet debt). Corporate financing, therefore, is likely to be used only by project sponsors with strong balance sheets.

Project financing debt, on the other hand, is typically non-recourse or limited recourse to the project sponsor and is not reflected on the balance sheet of the project sponsor. The lenders in project financing look to the anticipated cash flow from the project for repayment of the loan. Typically, the project sponsor creates a special purpose entity (“SPE”) that serves as the owner of the project, and as the borrower, under the project financing. Because the loans are non-recourse or limited recourse to the project sponsor, documentation for project financing is more extensive and complex than corporate financing and typically rely on conditions and financial covenants that provide comfort to the lenders as to the validity of cashflow projections and the reliability of debt service coverage. Although the above referenced structures have been described as loans, corporate and project financing transactions can involve public and/or private security issuances and lease-based transactions (such as sale-leaseback, operating and synthetic lease financings), in addition to commercial bank loans.

Thus, there is a need in the field of industrial project financing for a project financing system which avoids the financial risks to the project sponsor and balance sheet drag that are associated with corporate financings, and the higher cost and added documentation burdens that are associated with project financings. In short, there is a need for a hybrid of the advantageous features for both corporate and project financings, to provide low-cost, non-recourse financing.

### SUMMARY OF THE INVENTION

In one embodiment of the present invention, a method for financing a renewable energy generation project includes the step of a project developer identifying a pension fund as a potential provider of credit support. The project developer and the pension fund enter into an agreement, pursuant to which the pension fund agrees to provide credit support in connection with financing the project, and the project developer agrees to provide the pension find with a fee. Bonds, which may be variable rate demand bonds or tax credit bonds (“Bonds”), are issued by a public authority or utility for the benefit of a SPE which develops and owns the renewable energy generation project. The pension fund provides credit support for the Bonds, and fees are paid to the bond fund for the credit support. The proceeds of the bond offering are used to finance the project.

Variations of the basic method are possible. For example, the SPE for which the Bonds are issued can be a limited partnership, in which the project developer is the general partner, and other equity investors are the limited partners. The credit support provided by the pension fund may be in the form of a guaranty, or in the form of a “put” to the pension fund. The proceeds of the bond offering may be held in a trust for the benefit of the bondholders, in which case trustee is appointed to administer the Bonds and the trust account. The pension fund can be secured by a pledge of at least a portion of the assets of the SPE.

The financing method of this invention may further comprise the step of appointing a remarketing agent to (i) reset the interest rates on the Bonds, (ii) find buyers for tendered Bonds, and (iii) keep the Bonds substantially continuously placed in the market. A liquidity agent may be appointed, to provide liquidity support for ongoing remarketing of the Bonds.

In addition to the responsibilities discussed above, the project developer can perform additional tasks, including performing preliminary project development activity, including assessments of feasibility, siting, permitting, and environmental impact.

### BRIEF DESCRIPTION OF THE DRAWINGS

FIG. 1 is a schematic flowchart of an exemplary embodiment of the financing method according to the present invention.

### DETAILED DESCRIPTION OF THE INVENTION

The method of financing described herein (the “New Project Financing Method”) is a novel approach as compared to the traditional project financing structures. The New Project Financing Method is novel in that it gives project developers access to low-cost bond financing by creating an instrument that can be credit enhanced by highly creditworthy pension funds, thereby combining the advantages of corporate financing (low cost pricing associated with credit enhanced transactions) with the advantages of project financing (lowered risk to the provider of credit support). Pension funds would find making investments in projects utilizing the New Project Financing Method attractive because: (1) the New Project Financing Method is structured to limit credit enhancer's exposure to development risks, and (2) pension funds typically have investment guidelines that require their investment managers to make socially responsible investments (such as “green” energy generation projects). The result is low-cost, non-recourse financing, a unique hybrid of the best of traditional corporate and project financing.

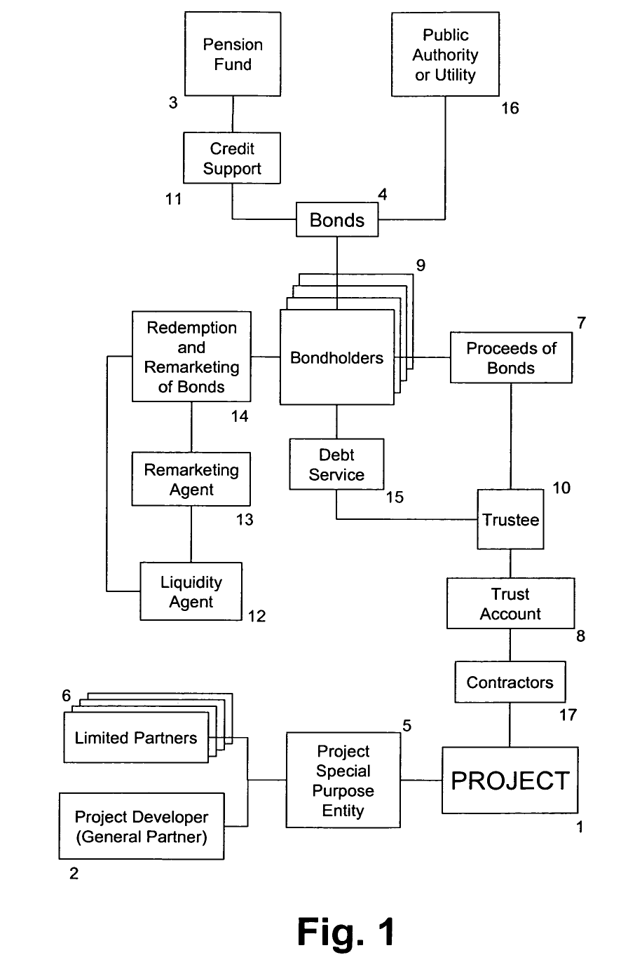

FIG. 1 shows a schematic flowchart of an embodiment of the New Project Financing Method according to the present invention. Typically, renewable energy generation projects (such as wind farms) and other “green” energy generation projects 1 are originated by a project developer 2. The project developer 2 undertakes preliminary feasibility studies and other necessary actions in connection with engineering, procuring and constructing the project, such as siting, permitting and environmental assessment. A pension fund 3 is identified as the principal provider of credit support by the project developer early in the development process. The project developer 2 and the pension fund 3 will typically enter into a memorandum of understanding or a commitment letter, pursuant to which the pension fund agrees to provide credit support in connection with financing the project in return for a fee. Until the bond offering is consummated, the project developer 2 carries all of the costs associated with the development of each project until the construction phase of the project. In addition, the project developer 2 typically hires a consultant for the purposes of conducting an independent feasibility study of the project 1. The feasibility study will establish, for the benefit of the pension fund 3 (as well as for the bondholders and other debt providers and equity investors) the viability of the project 1 in respect of cashflow projections and debt service 15 coverage.

As discussed above, the project will be financed with the proceeds of Bonds 4, which will be issued by a public authority or utility 16 for the benefit of the SPE 5 that is created for the purpose of developing and owning the project. The SPE will also be capitalized with equity investments from the project developer 2 and possibly other equity investors 6. Various ownership structures may be used for the SPE. The SPE can be structured as a corporation, a partnership (general and limited), a trust or a contractual joint venture. The ultimate structure of the SPE will depend on tax and other considerations of the parties. One example of an ownership structure is the limited partnership, with the project developer 2 as the general partner and other equity investors as the limited partners 6. The proceeds of the bond offering 7 will be held in a trust account 8 for the benefit of the bondholders 9 and will be used to finance construction costs (for construction contractors 17) and other development costs (capital expenses) of the project 1. Such proceeds 7 will also be used to reimburse the project developer 2 for its costs and expenses. A trustee 10 will be appointed to administer the Bonds 4 (including the payment of debt service 15) and the trust account 8.

As previously discussed, a pension fund 3, or a financial intermediary, will provide credit support 11 for the Bonds. Typically, credit support 11 will be in the form of a guaranty, but need not be limited to guarantees. Other forms of credit support, such as a “put” to the pension fund or a cash-based facility, may be used in the event a pension fund 3 is expressly prohibited from guaranteeing the obligations of third parties. The pension fund 3 will be paid a fee for providing the credit support 11. The Bonds 4 will be rated by nationally-recognized rating agencies and have short-term credit ratings that are at least equal to those of the pension fund's own short-term credit ratings. The pension fund may be secured by a pledge of all or a portion of the assets of the SPE 5, including the SPE's rights under off-take power supply arrangements, if any.

The Bonds 4 are typically variable rate demand bonds, which means that the rate of interest accruing on the Bonds 4 is reset periodically (typically on a weekly or other short-term basis) and that the Bonds 4 may be put back to the SPE 5 or a liquidity agent 12 (meaning the SPE or a liquidity agent 12 would be required to purchase the Bonds 4 at a pre-agreed upon price) by the bondholders 9 at any time at par (ie., 100% of the face principal amount) plus accrued interest with a week's (or such other short-term period's) notice. Although the Bonds 4 have a long term maturity, because the Bonds 4 can be put with a week's (or such other short-term period's) notice, the Bonds 4 will be priced at interest rates that are typical for short-term issues, which historically are much lower than long-term bond interest rates. A remarketing agent 13 will be appointed (i) to reset the interest rates on a periodic basis, (ii) to find new buyers for tendered Bonds and (iii) to keep the Bonds continuously placed in the market. A liquidity agent 12 (typically a bank or other financial institution) will also be appointed to provide liquidity support in respect of the continuing remarketing 14 of the Bonds.

If the Bonds 4 are issued as tax credit bonds, debt service 15 will consist only of the principal payments on the Bonds 4 and the interest-setting arrangements described in the preceding paragraph will be unnecessary. This is because bondholders 9 will receive credits on their federal income tax liability in lieu of interest on the Bonds 4.

While it is apparent that the illustrative embodiments of the invention herein disclosed fulfill the objectives stated above, it will be appreciated that numerous modifications and other embodiments may be devised by those skilled in the art. Therefore, it will be understood that the appended claims are intended to cover all such modifications and embodiments which come within the spirit and scope of the present invention.

What is claimed:

1. A method for financing a renewable energy generation project, comprising the steps of:
identifying a pension fund as a potential provider of credit support for the purpose of financing a renewable energy generation project;
entering into an agreement between a project developer of the renewable energy generation project and the pension fund in which the pension fund agrees to provide credit support in connection with financing the project and the project developer agrees to provide the pension fund with a fee;
issuing bonds, by a public authority or utility, for the benefit of a special purpose entity which develops and owns the renewable energy generation project;
providing credit support for the bonds by the pension fund;
paying fees to the bond fund for the credit support;
holding the proceeds of the bond offering in a trust for the benefit of the bondholders; and
using the proceeds of the bond offering to finance the project.

2. The method of claim 1 wherein the special purpose entity is a limited partnership.

3. The method of claim 2 wherein the project developer is the general partner and other equity investors are the limited partners.

4. The method of claim 1 wherein the credit support provided by the pension fund is in the form of a guaranty.

5. The method of claim 1 wherein the credit support provided by the pension fund is in the form of a “put” to the pension fund.

6. The method of claim 1, wherein the bonds are variable rate demand bonds, and further comprising the step of appointing a remarketing agent to (i) reset the interest rates on the bonds, (ii) find buyers for tendered bonds, and (iii) keep the bonds substantially continuously placed in the market.

7. The method of claim 1, where the bonds are tax credit bonds.

8. A method for financing a renewable energy generation project, comprising the steps of:
identifying a pension fund as a potential provider of credit support;
entering into an agreement between a project developer and the pension fund in which the pension fund agrees to provide credit support in connection with financing the project and the project developer agrees to provide the pension fund with a fee;
issuing bonds, by a public authority or utility, for the benefit of a special purpose entity which develops and owns the renewable energy generation project;
providing credit support for the bonds by the pension fund;
paying fees to the bond fund for the credit support; and
using the proceeds of the bond offering to finance the project.

9. The method of claim 8 wherein the special purpose entity is a limited partnership.

10. The method of claim 9 wherein the project developer is the general partner and other equity investors are the limited partners.

11. The method of claim 8 wherein the credit support provided by the pension fund is in the form of a guaranty.

12. The method of claim 8, wherein the bonds are variable rate demand bonds, and further comprising the step of appointing a remarketing agent to (i) reset the interest rates on the bonds, (ii) find buyers for tendered bonds, and (iii) keep the bonds substantially continuously placed in the market.

13. The method of claim 8, wherein the bonds are tax credit bonds.

14. The method of claim 8 further comprising appointment of a liquidity agent to provide liquidity support for ongoing remarketing of the bonds.

15. The method of claim 8 further comprising the steps of:
placement of the proceeds of the bond offering into a trust account; and
appointment of a trustee to administer the bonds and the trust account.

16. A method for financing a renewable energy generation project, comprising the steps of:
a project developer performing preliminary project development activity, including assessments of feasibility, siting, permitting, and environmental impact;
the project developer identifying a pension fund as a potential provider of credit support;
the project developer and the pension fund entering into an agreement pursuant to which the pension fund agrees to provide credit support in connection with financing the project and the project developer agrees to provide the pension fund with a fee;
issuance of variable rate demand bonds, by a public authority or utility, for the benefit of a special purpose entity which (i) develops and owns the renewable energy generation project and (ii) serves as the borrower under the project financing;
providing credit support for the bonds by the pension fund;
payment of fees to the bond fund for the credit support; and
using the proceeds of the bond offering to finance the project.

17. The method of claim 16 wherein the special purpose entity is a limited partnership.

18. The method of claim 17 wherein the project developer is the general partner and other equity investors are the limited partners.

19. The method of claim 16 wherein the credit support provided by the pension fund is in the form of a guaranty.

20. The method of claim 16 wherein the credit support provided by the pension fund is in the form of a “put” to the pension fund.

21. The method of claim 16, further comprising the step of appointing a remarketing agent to (i) reset the interest rates on the bonds, (ii) find buyers for tendered bonds, and (iii) keep the bonds substantially continuously placed in the market.

22. The method of claim 16, further comprising the step of securing the pension fund by a pledge of at least a portion of the assets of the special purpose entity.
